(19) United States
(12) Patent Application Publication
(10) Pub. No.: US 2026/0354954 A1
(43) Pub. Date: Nov. 12, 2026

(54) DENTAL FLOSSING DEVICE

(71) Applicant: Fridababy, LLC, Miami, FL (US)

(72) Inventors: Chelsea HIRSCHHORN, Miami Beach, FL (US); Stuart Harvey LEE, Cornwall on Hudson, NY (US); Adrian Candela VAILLARD, Denver, CO (US); Brandon RODRIGUEZ, N. Pinellas Park, FL (US); Matthew SAXTON, Moorpark, CA (US)

(21) Appl. No.: 19/667,210

(22) Filed: May 4, 2026

Related U.S. Application Data
(60) Provisional application No. 63/800,876, filed on May 6, 2025.

(51) Int. Cl. A61C 15/04

(52) U.S. Cl. CPC A61C 15/047; A61C 15/048

(57) ABSTRACT

A flosser includes a handle that includes a bumper and a stepped mounting interface having at least a first wall and a second wall defining a vertical offset. The flosser also includes a flosser head removably attachable to the handle. The flosser head includes a pair of opposing arms, a floss strand tensioned between the opposing arms, and a step projecting from an inner surface of the flosser head and configured to selectively engage either the first wall or the second wall of the stepped mounting interface. Engagement of the step with the first wall positions the bumper a first distance from the floss strand, and engagement of the step with the second wall positions the bumper a second distance from the floss strand, the second distance being greater than the first distance.

### CROSS-REFERENCE TO RELATED APPLICATION

The present application claims the benefit of U.S. Provisional Patent Application No. 63/800,876, filed on May 6, 2025, and titled “MOTORIZED DENTAL FLOSSING DEVICE,” the disclosure of which is expressly incorporated by reference in its entirety.

### FIELD OF THE DISCLOSURE

Aspects of the present disclosure generally relate to motorized dental flossing devices, and more specifically to providing adjustable flossing offsets and gum protection in motorized dental flossing devices.

### BACKGROUND

An electric flosser is an example of a handheld oral hygiene device designed to assist users in cleaning between teeth using a powered mechanism. Most electric flossers include a motorized handle, a flossing head, and a strand of flossing material suspended between a pair of tines. When activated, the motor produces mechanical motion, typically in the form of vibrations or lateral oscillations, which is transmitted to the flossing material to help remove plaque and stimulate the gums. The flossing head may be interchangeable and may differ in shape, size, or floss tension to accommodate various users and dental needs. Many electric flossers are designed with ergonomic features such as contoured grips, angled heads, and intuitive controls to improve user comfort and effectiveness. Some designs also include features such as pressure sensors, timers, or water resistance, making them suitable for daily use in a variety of environments.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1A illustrates an example of an electric flosser, in accordance with various aspects of the present disclosure.

FIG. 1B illustrates an example of a rear view of the electric flosser, in accordance with various aspects of the present disclosure.

FIG. 1C illustrates an example of a front view of the electric flosser, in accordance with various aspects of the present disclosure.

FIG. 1D illustrates an example of a side view of the electric flosser, in accordance with various aspects of the present disclosure.

FIG. 2 illustrates an example of a flosser head with arms supporting a floss strand and a bumper, in accordance with various aspects of the present disclosure.

FIG. 3A illustrates an example of a mounting interface between a flosser handle and a replaceable flosser head, in accordance with various aspects of the present disclosure.

FIG. 3B illustrates an example of an enlarged view of the mounting interface, in accordance with various aspects of the present disclosure.

FIG. 4A illustrates an example of the flosser head mounted in a first position, in accordance with various aspects of the present disclosure.

FIG. 4B illustrates an example of the flosser head mounted in a second position, in accordance with various aspects of the present disclosure.

FIG. 4C illustrates an example of a cross-sectional view of the mounting interface, in accordance with various aspects of the present disclosure.

FIG. 4D illustrates an example of a perspective view of the flosser head, in accordance with various aspects of the present disclosure.

FIG. 4E illustrates an example of a perspective view of the flosser head, in accordance with various aspects of the present disclosure.

FIG. 4F illustrates an example of a cross-sectional view of the flosser head, in accordance with various aspects of the present disclosure.

FIG. 4G illustrates an example of a cross-sectional view of the mounting interface, in accordance with various aspects of the present disclosure.

FIG. 5A illustrates an example of a top-down view of a standard flosser head, in accordance with various aspects of the present disclosure.

FIG. 5B illustrates an example of a bottom-up view of a standard flosser head, in accordance with various aspects of the present disclosure.

FIG. 5C illustrates an example of a perspective view of a standard flosser head, in accordance with various aspects of the present disclosure.

FIG. 5D illustrates an example of a side view of a standard flosser head, in accordance with various aspects of the present disclosure.

FIG. 6A illustrates an example of a top perspective view of an orthodontic flosser head, in accordance with various aspects of the present disclosure.

FIG. 6B illustrates an example of a top-down view of an orthodontic flosser head, in accordance with various aspects of the present disclosure.

FIG. 6C illustrates an example of a side view of an orthodontic flosser head, in accordance with various aspects of the present disclosure.

FIG. 7 illustrates an example of a perspective view of the flosser head assembly, in accordance with various aspects of the present disclosure.

FIG. 8 illustrates an example of a flowchart of a process for using the flosser, in accordance with various aspects of the present disclosure.

FIG. 9 illustrates an example of a flowchart of a process for manufacturing the electric flosser and the flosser head, in accordance with various aspects of the present disclosure.

### SUMMARY

Various aspects of the present disclosure are directed to a flosser. The flosser may include a handle that includes a bumper and a stepped mounting interface having at least a first wall and a second wall defining a vertical offset. The flosser also includes a flosser head removably attachable to the handle. The flosser head includes a pair of opposing arms, a floss strand tensioned between the opposing arms, and a step projecting from an inner surface of the flosser head and configured to selectively engage either the first wall or the second wall of the stepped mounting interface. Engagement of the step with the first wall positions the bumper a first distance from the floss strand, and engagement of the step with the second wall positions the bumper a second distance from the floss strand, the second distance being greater than the first distance.

Some aspects of the present disclosure are directed to a method of using a flosser. The method comprises selecting a flosser head having a pair of opposing arms and a floss strand tensioned therebetween. The method further comprises orienting the flosser head in a first or second position relative to a handle, the handle comprising a stepped mounting interface with a first wall and a second wall that are vertically arranged. The method also comprises attaching the flosser head to the handle such that a step on the flosser head engages either the first wall or the second wall of the stepped mounting interface. The method still further comprises flossing teeth such that a bumper at a distal end of the handle contacts the top of the teeth and prevents the floss strand from extending beyond a predefined depth into the gums of a user.

In some aspects, a method of manufacturing a flosser includes forming a handle having a neck and a stepped mounting interface that comprises first and second walls arranged vertically with respect to one another. A bumper may be attached to a distal end of the neck so that the bumper is positioned adjacent to the stepped mounting interface. The method may further include forming a flosser head having a pair of opposing arms, a step projecting from an inner surface of the flosser head, and a floss strand tensioned between the opposing arms. The flosser head may be configured to be removably attachable to the stepped mounting interface such that the step selectively engages either the first wall or the second wall of the stepped mounting interface, where engagement of the step with the first wall positions the bumper a first distance from the floss strand and engagement of the step with the second wall positions the bumper a second, greater distance from the floss strand.

Aspects generally include a method and apparatus as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

An electric flosser is a handheld oral hygiene device designed to assist users in cleaning between teeth using a powered mechanism. Most electric flossers include a motorized handle, a flossing head, and a strand of flossing material suspended between a pair of tines. When activated, the motor produces mechanical motion, typically in the form of vibrations or lateral oscillations, which is transmitted to the flossing material to help remove plaque and stimulate the gums. The flossing head may be removable and also interchangeable. Flossing heads may differ in shape, size, or floss tension to accommodate various users and dental needs. Many electric flossers are designed with ergonomic features such as contoured grips, angled heads, and intuitive controls to improve user comfort and effectiveness. Some designs also include features such as pressure sensors, timers, or water resistance, making them suitable for daily use in a variety of environments. Additionally, conventional electric flossers may not adequately accommodate users with orthodontic appliances such as braces, where bulky floss heads or rigid arm geometries may prevent effective access to interdental spaces around brackets and archwires.

Various aspects of the present disclosure are directed to an electric flosser that addresses these and other limitations by introducing one or more features, such as dual-mode flossing heads, adjustable floss-to-bumper offsets, orthodontic head variants with tapered arms, and/or dedicated bumper structures that limit the depth of floss penetration. For ease of explanation, the electric flosser may also be referred to as a flosser or a device. In some examples, the flosser includes a selectable engagement geometry that allows users to toggle between different offset distances specified for either baby teeth or adult teeth. Additionally, or alternatively, the electric flosser may incorporate a bumper positioned above the flossing strand to act as a mechanical stop, protecting the gums during use. These and other features aim to improve safety, comfort, and versatility, enabling a single flosser to effectively serve users of different ages and dental configurations, including those with orthodontic hardware.

In some examples, the electric flosser may be specified for children, such as children aged 6 to 10. Still, the electric flosser may be used by children or adults. In some examples, the electric flosser includes an elongated handle with a soft-touch grip to enhance comfort and usability for small hands. A removable battery cap at a bottom of the handle houses a single AA battery, which powers an internal motor. In other examples, a rechargeable battery may be used. An on/off button located on the handle activates the device’s ultrasonic action. In some examples, the ultrasonic action may deliver between approximately 5,000 and 10,400 strokes per minute, depending on the selected speed setting. This vibration assists with effective flossing without requiring advanced dexterity from the child.

Attached to the top of the handle is a replaceable floss head, which snaps on and off for easy replacement. Each floss head includes a tensioned, floss strand stretched between two support arms. The floss strand may be flavored. The floss head may be available in various versions, including a standard model for typical dental use and an orthodontic version with thinner arms designed to pass between braces and teeth. In some examples, the floss head includes an integrated bumper located above the floss strand. This bumper acts as a physical stop against the top surfaces of the teeth, limiting the floss’s vertical movement and preventing it from pressing too deeply into the gums. This design promotes safe flossing and helps prevent gum injury, which is important for young users still developing good oral hygiene habits.

The electric flosser may also include a two-mode head attachment system. Both the flosser handle (e.g., mounting interface) and the floss head feature dual-step geometries that allow the same floss head to be attached in two different orientations. Depending on how the head is mounted, the vertical distance between the floss strand and the bumper may be set at two different offsets, such as a 3 mm offset or a 5 mm offset, for example. This allows the device to be configured for baby teeth (requiring a shallower floss offset) or for adult teeth (requiring a deeper offset). The dual-mode geometry enables a single product to adapt to a growing child’s changing dentition, improving long-term usability.

The snap-on/off mechanism of the floss head ensures secure placement while maintaining ease of use. The head can be removed and replaced without tools, supporting hygienic use and reducing the risk of improper assembly. The ultrasonic action of the motor, combined with the tensioned floss strand, delivers an enhanced cleaning experience, helping remove plaque and food particles from between teeth and along the gumline. Because the device does not rely on water pressure, it offers a cleaner and less messy alternative to conventional water flossers.

In addition to the standard and orthodontic floss head variants, alternative embodiments of the invention may include bumpers made of silicone, thermoplastic elastomers, or other flexible biocompatible materials. The handle may be contoured or decorated with child-friendly graphics. Some models may include rechargeable batteries or support other floss offsets through modified geometries or adjustable heads.

In various aspects of the present disclosure, the flosser may be an electric flosser or a non-electric flosser. In electric configurations, the handle may include a motor configured to impart vibration or reciprocating motion to the floss strand. In non-electric configurations, the flosser may omit the motor and may be manually actuated while retaining the handle, bumper, and removable floss head features described herein. For ease of explanation, various aspects may be described with respect to the electric flosser, however, the non-electric flosser is also contemplated.

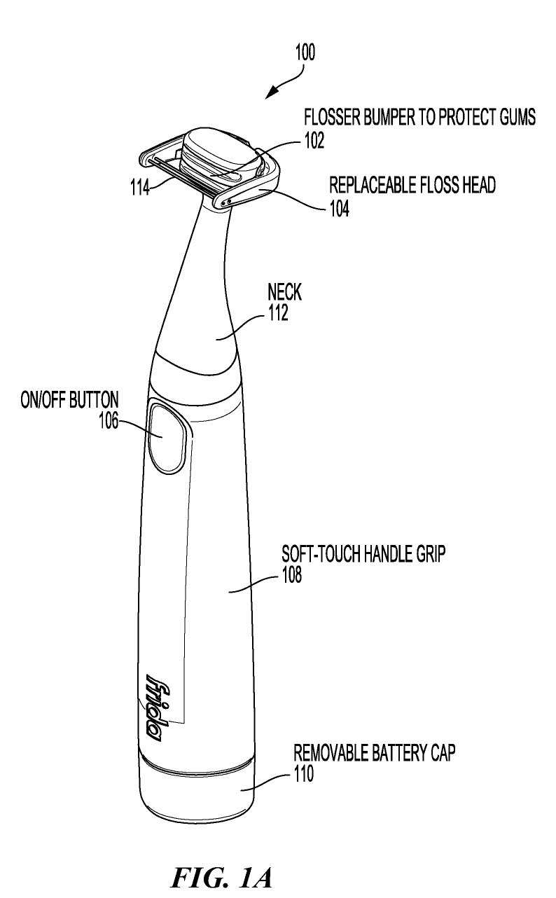

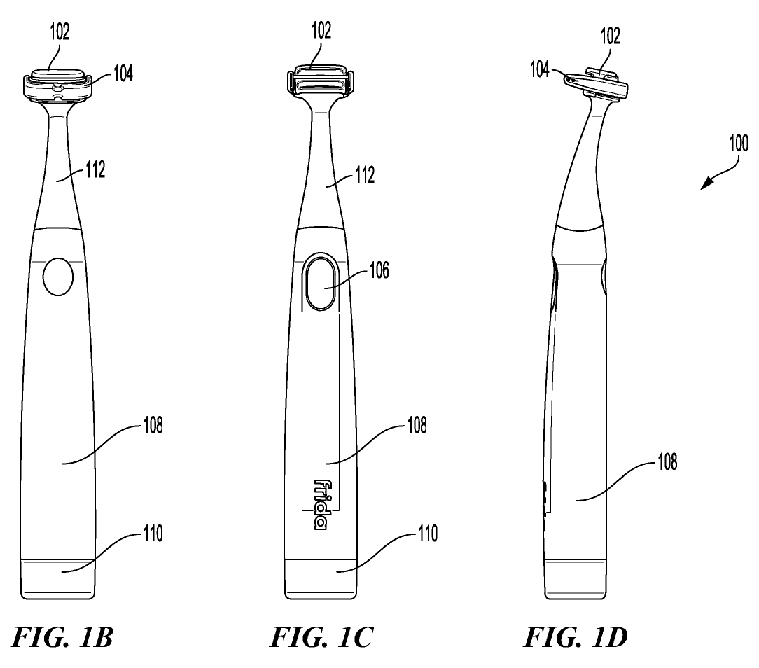

FIGS. 1A, 1B, 1C, and 1D illustrate examples of the electric flosser 100 in accordance with various aspects of the present disclosure. As shown in the examples of FIGS. 1A, 1B, 1C, and 1D, the electric flosser 100 includes a flosser bumper 102 positioned at a distal end of a neck 112 to protect the user’s gums by limiting the insertion depth of the floss during operation. The flosser bumper 102 functions as a mechanical stop, contacting the crown of the tooth to prevent excessive downward pressure and gum irritation. The bumper 102 may be formed from a compliant, biocompatible material such as silicone or thermoplastic elastomer (TPE) to provide gentle cushioning while maintaining durability under repeated contact. The selected material is preferably soft enough to absorb impact when pressed against the teeth yet resilient enough to retain its shape and functionality after repeated use and cleaning. Still, other materials are contemplated for the bumper 102, depending on the desired balance between flexibility, tactile response, and longevity.

In some examples, the bumper 102 may be formed from a dual-layer composite structure including a soft outer layer of medical-grade silicone and a firmer inner substrate of polyurethane or polypropylene. The dual-layer configuration provides a compliant contact surface that protects the enamel and gums while ensuring the bumper remains mechanically stable when integrated with the mounting interface. The outer layer may have a Shore A hardness between approximately 20 and 50, whereas the inner substrate may exhibit a higher hardness to resist deformation under load.

In another example, the bumper 102 may be manufactured from a viscoelastic gel material, such as a thermoplastic gel elastomer (TPG), which offers superior shock absorption and surface conformity. This type of material is particularly suitable for pediatric or sensitive-gum users, as it conforms to tooth contours and dissipates localized pressure. The gel-based bumper may be co-molded or insert-molded into the flosser head 104 to create a seamless, integrated structure that is resistant to peeling or detachment.

In yet another example, the bumper 102 may include a rigid internal support frame encapsulated within a soft elastomeric overmold. The internal frame may be composed of metal or reinforced polymer and serves to maintain dimensional stability and define the mounting geometry, while the elastomeric overmold provides the desired cushioning and user comfort. This layered construction ensures consistent alignment between the bumper 102 and the flosser head 104, even after extended use.

In some examples, the bumper 102 may incorporate antimicrobial additives or coatings, such as silver ions, zinc oxide, or quaternary ammonium compounds, to inhibit bacterial growth and maintain hygiene between uses. The bumper may also include replaceable pads or sleeves that can be detached for cleaning or replaced periodically. In other examples, the bumper 102 may feature a textured surface—such as microgrooves, dimples, or ribs—to increase flexibility, improve grip against the tooth surface, and facilitate fluid drainage during flossing.

Beyond silicone and TPE, the bumper 102 may be constructed from other compliant, biocompatible materials such as medical-grade thermoplastic polyurethane (TPU), ethylene-vinyl acetate (EVA), or soft copolyester elastomers (COPE). These materials can provide enhanced tear resistance, hydrolytic stability, or customizable elasticity. For disposable or cost-sensitive designs, the bumper 102 may be formed from molded polyethylene or polypropylene with a reduced wall thickness engineered to flex under pressure while remaining lightweight and easy to produce.

In addition to serving as a gum-protective element, the bumper 102 may also function as part of the mounting interface that connects to the replaceable floss head 104. In such examples, the bumper 102 may include integral features such as alignment ribs, detent tabs, or snap-fit couplings that ensure secure attachment and proper orientation of the head relative to the handle. Integrating the bumper 102 with the mounting interface simplifies assembly, reduces the number of components, and maintains precise alignment between the flosser head 104 and the handle. This configuration allows the bumper 102 to serve both as a protective feature and as a structural coupling element within the overall design of the electric flosser 100.

In alternate configurations, the bumper and adjustable mounting features may be integrated into the flosser head 104 itself rather than being located on the handle or mounting interface. In such examples, the flosser head 104 may include an integral bumper structure that extends above the floss strand 114 and is configured to contact the occlusal surfaces of the teeth during use. The adjustable offset may be achieved through a multi-position mounting mechanism built into the head, such as a sliding collar, rotatable cam, or indexed adjustment feature that allows the user to select between different floss-to-bumper distances. This head-integrated approach may simplify the handle design and allow for greater flexibility in head replacement and customization. The bumper may be molded directly into the head structure or attached as a replaceable component, and may be constructed from the same compliant materials described previously, such as silicone or thermoplastic elastomer.

The replaceable floss head 104 is removably attached to the mounting interface to allow for hygienic reuse and easy replacement when the floss strand becomes worn or frayed. The floss head 104 includes one or more arms that extend outward to hold a tensioned strand of flossing material 114. The head 104 may snap securely into a receiving interface of the neck 112 via a stepped or keyed interface, ensuring proper alignment and consistent vibration transfer during operation. In some examples, the flosser head 104 can be interchanged with alternative versions, such as an orthodontic head designed with thinner arms to maneuver between braces or dental hardware.

The handle 108 of the electric flosser 100 includes an on/off button 106 positioned at a location along the front surface of the handle to enable intuitive single-hand operation. The button 106 may be implemented as a sealed membrane switch or soft-touch actuator to prevent moisture ingress while providing tactile feedback when pressed. The handle 108 may be formed as a soft-touch grip from a non-slip elastomeric material to enhance comfort and control during use. The handle 108 contour follows the natural curvature of the user’s hand, allowing stable handling even when wet, which is particularly useful for children or individuals with reduced dexterity.

At the bottom of the handle 108, a removable battery cap 110 provides access to a power compartment configured to receive one or more batteries. The cap 110 may secure to the handle via a twist-lock or snap-fit mechanism, ensuring a watertight seal while allowing easy replacement of the power source. The power source may be a single AA battery or a rechargeable battery, such as a lithium-ion cell battery, that connects to an internal charging port.

In some examples, the electric flosser may include a motor configured to operate at multiple selectable speeds to accommodate different user preferences and cleaning intensities. The motor may be configured to operate at a first speed of approximately 2,500 revolutions per minute (RPM) and a second speed of approximately 5,200 RPM. When converted to strokes per minute (SPM), where each revolution produces two strokes, the first speed may deliver approximately 5,000 SPM, and the second speed may deliver approximately 10,400 SPM. The user may select between the first speed and the second speed via a control interface, such as a multi-position button or a dedicated speed selector switch located on the handle. The lower speed setting may provide gentler flossing action suitable for sensitive gums or pediatric users, while the higher speed setting may provide more aggressive plaque removal for adult users or areas with heavier buildup.

The disclosed stroke rates of approximately 5,000 SPM and approximately 10,400 SPM are exemplary and provided for illustration purposes. Aspects of the present disclosure are not limited to these specific stroke rates. Other stroke rates are contemplated and may be selected based on user preferences, motor specifications, power source characteristics, or intended cleaning intensity. In some examples, the motor may be configured to operate at stroke rates below 5,000 SPM for gentler cleaning or above 10,400 SPM for more aggressive plaque removal, and/or stroke rates between 5,000 SPM and 10, 400 SPM. The motor may also be configured to support three or more selectable speed settings, providing additional flexibility for users with varying oral care needs.

As shown in the examples of FIGS. 1A, 1B, 1C, and 1D, a neck portion 112 extends upward from the handle 108. The handle 108 may transition smoothly into the neck 112 through a contoured or tapered junction that provides structural continuity and ergonomic handling. The neck 112 is angled to provide an ergonomic reach into the mouth and to allow the flosser strand 114 to align naturally with the interdental spaces. The curvature of the neck 112 may also reduce wrist strain by minimizing the motion required to access posterior teeth. The flosser head 104 may be removably attached to the distal end of the neck 112 via a snap-fit mounting interface, with the head 104 oriented substantially perpendicular to the longitudinal axis of the neck 112. Together, the flosser bumper 102, replaceable head 104, and ergonomic handle features form an integrated structure that balances comfort, safety, and effectiveness during daily flossing routines.

FIG. 1B illustrates an example of a rear view of the electric flosser 100, showing the symmetrical shape of the handle 108 and the transition between the handle 108 and the neck 112. The replaceable floss head 104 is mounted substantially perpendicular to the neck 112 via a snap-fit interface. The flosser bumper 102 projects slightly forward from the flosser head 104, ensuring that it remains the first point of contact with the user’s teeth. This configuration allows the bumper 102 to function as a protective guard while enabling consistent vibration transfer from the handle 108 through the neck 112 to the floss strand 114. The rear view further emphasizes the streamlined geometry and balanced proportions of the device, which contribute to its ease of use and comfortable handling.

FIG. 1C illustrates an example of a front view of the electric flosser 100, highlighting the alignment of the flosser bumper 102, replaceable floss head 104, and neck 112 along the longitudinal axis of the handle. An on/off button 106 may be defined (e.g., centered) on the front face for intuitive access by the user’s thumb during operation. The handle’s soft-touch grip 108 extends downward to the removable battery cap 110, which seals the battery compartment while maintaining a smooth ergonomic contour.

FIG. 1D illustrates an example of a side view of the electric flosser 100, illustrating the curvature of the neck 112 relative to the handle and the offset angle of the flosser head 104. This angled configuration facilitates access to posterior teeth and promotes a natural wrist position during flossing. The side profile also shows the gradual taper of the handle and the integrated placement of the soft-touch grip 108, which provides secure handling even when wet. The on/off button 106 is slightly recessed to prevent accidental activation while maintaining tactile feedback.

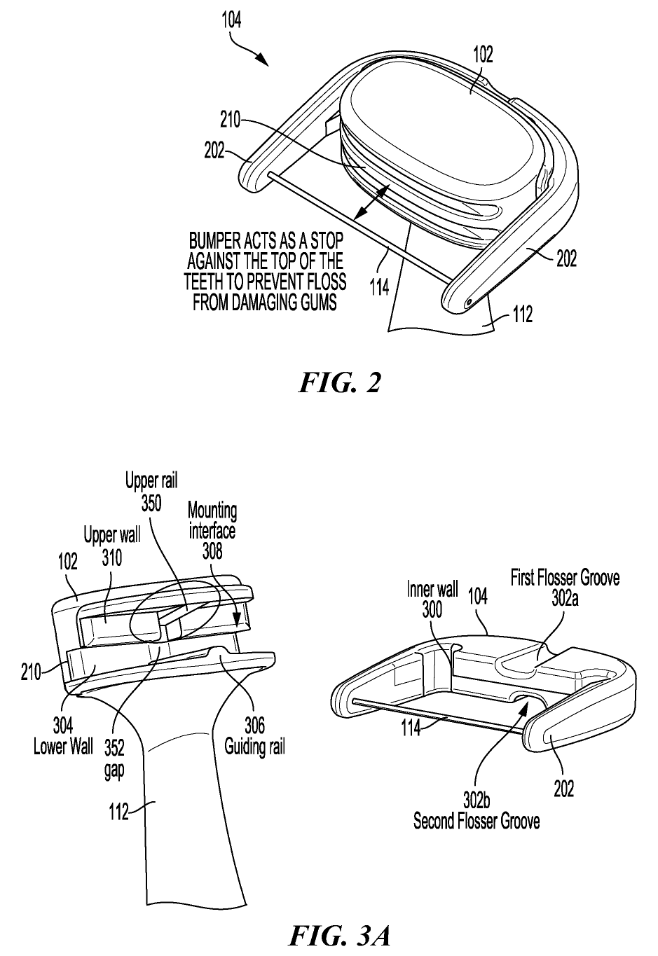

FIG. 2 illustrates an example of the flosser head 104 of the electric flosser 100 in accordance with various aspects of the present disclosure. The flosser head 104 includes a pair of outwardly extending arms 202 that secure a length of floss strand 114 stretched taut across an open end of the head between the arms 202. The floss strand 114 is configured to enter the interdental space between adjacent teeth during operation, removing plaque and food particles. Each arm 202 is contoured to provide sufficient tension on the floss strand 114 while maintaining sufficient rigidity to transmit vibration generated by the handle 108 to the floss strand 114. The arms 202 may be formed of a durable polymer material capable of withstanding repeated loading and cleaning cycles without fatigue or deformation. In some embodiments, the arms 202 are molded from high-strength engineering plastics such as acrylonitrile butadiene styrene (ABS), polycarbonate (PC), or a nylon-based resin reinforced with glass or carbon fibers. These materials provide a balance of stiffness and flexibility, allowing the arms 202 to maintain tension on the floss strand 114 while efficiently transmitting vibrational energy from the handle 108 to the floss strand 114. A space may be defined between the floss strand 114 and an outer wall 210 of the bumper 102.

In alternate implementations, the arms 202 may be constructed from composite materials that incorporate an internal reinforcement core, such as stainless-steel wire or an embedded carbon-fiber rod, encased in a polymer overmold. This composite configuration increases tensile strength and fatigue resistance while preserving the smooth, biocompatible surface of the flosser head 104. Such reinforcement may be advantageous in higher-frequency models or ultrasonic configurations where repeated oscillations could otherwise lead to creep or stress cracking.

In yet another example, the arms 202 may be integrally molded with the base of the flosser head 104 as a single piece using an injection molding or overmolding process. This monolithic structure enhances durability and eliminates joints or seams that could harbor bacteria. For devices designed for young children, the arms 202 may instead be formed from a softer thermoplastic elastomer (TPE) or polypropylene blend to allow controlled flexibility, reducing the risk of accidental injury while maintaining enough rigidity to tension the floss strand 114.

In some variations, the arms 202 may also include internal cavities or ribs that reduce material weight without compromising structural integrity. The inner surfaces of the arms 202 can be contoured or coated with a low-friction layer, such as a thin polytetrafluoroethylene (PTFE) film, to minimize wear on the floss strand 114 and facilitate smooth oscillation. The arms 202 may further include textured grip zones or matte finishes to improve user handling when attaching or removing the flosser head 104.

Across these examples, the materials and geometry of the arms 202 are selected to balance flexibility, tensile strength, and user safety. Whether configured as a rigid composite or a flexible polymer structure, the arms 202 are engineered to retain dimensional stability through repeated use, cleaning, and exposure to moisture, ensuring consistent floss tension and long-term performance of the electric flosser 100.

The flosser bumper 102 is positioned above the floss strand 114 and functions as a mechanical stop to protect the user’s gums. During use, when the user presses the flosser head 104 toward the teeth, the bumper 102 contacts the occlusal or incisal surfaces of the teeth before the floss strand 114 can penetrate too deeply into the gingival tissue. This controlled spacing ensures that the floss strand 114 cleans effectively within the sulcus region while preventing gum irritation or bleeding. The bumper 102 may be composed of a compliant or rounded elastomeric material, such as silicone or thermoplastic elastomer, which provides a cushioned interface against the tooth surface. The bumper’s flexible geometry allows it to deform slightly upon contact, further improving comfort and safety.

The bumper 102 may include a plurality of horizontal grooves or ribs extending along its surface facing the floss strand 114. These grooves enhance flexibility and increase the contact surface area when the bumper 102 presses against the teeth. The ribbed structure also improves the bumper’s ability to conform to varying tooth shapes while maintaining consistent pressure distribution. The neck 112 extends downward from the flosser head 104, providing a structural transition to the handle of the device and supporting the mounting interface that secures the flosser head in place. The integration of the bumper 102, arms 202, and floss strand 114 creates a compact, functional design that promotes safe and effective flossing for users of all ages.

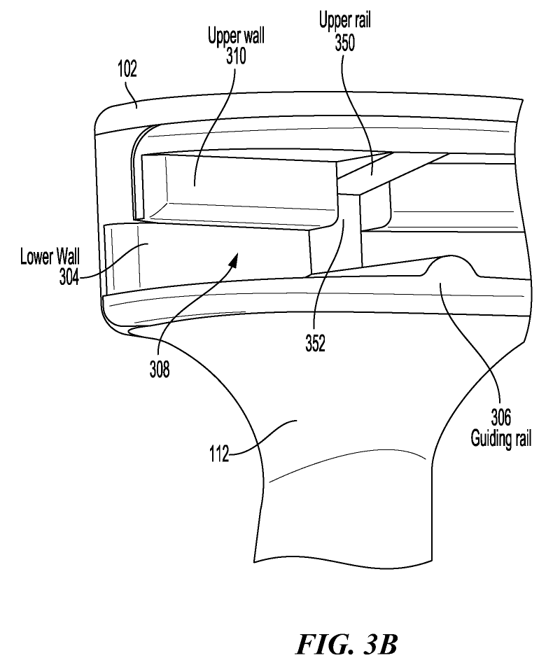

FIG. 3A illustrates an example of the mounting interface 308 between the flosser handle and the flosser head in accordance with various aspects of the present disclosure. For ease of explanation, not every element from the previous figures is labeled. The illustration on the left side of FIG. 3 depicts the upper portion of the flosser handle, which includes a dual-level mounting interface 308 designed to receive the flosser head 104 in two distinct positions. The flosser head 104 is the disposable component that may be removed and replaced, while the bumper 102 remains attached to the handle structure as part of the mounting interface 308. The dual-level interface includes two vertically offset ledges or steps that define separate attachment heights. The ledges correspond to a lower wall 304 and an upper wall 310. As discussed further below, a portion of each of the lower wall 304 and upper wall 310 wraps partially around the bumper 102, such that the bumper 102 is partially enclosed by both the upper wall 310 and lower wall 304. Depending on how the user mounts the flosser head 104, the vertical spacing between the floss strand 114 and the bumper 102 changes, providing selectable floss-to-bumper offsets suitable for different users or tooth geometries.

As previously discussed, the handle portion includes a neck 112 extending upward from the main body and terminating at the mounting interface 308. The lower wall 304 is substantially perpendicular to a guiding rail 306 that extends along the horizontal surface of the mounting interface 308. The guiding rail 306 serves as an alignment feature, providing a track for the flosser head 104 to slide onto the handle. This ensures stable positioning and prevents lateral misalignment during assembly.

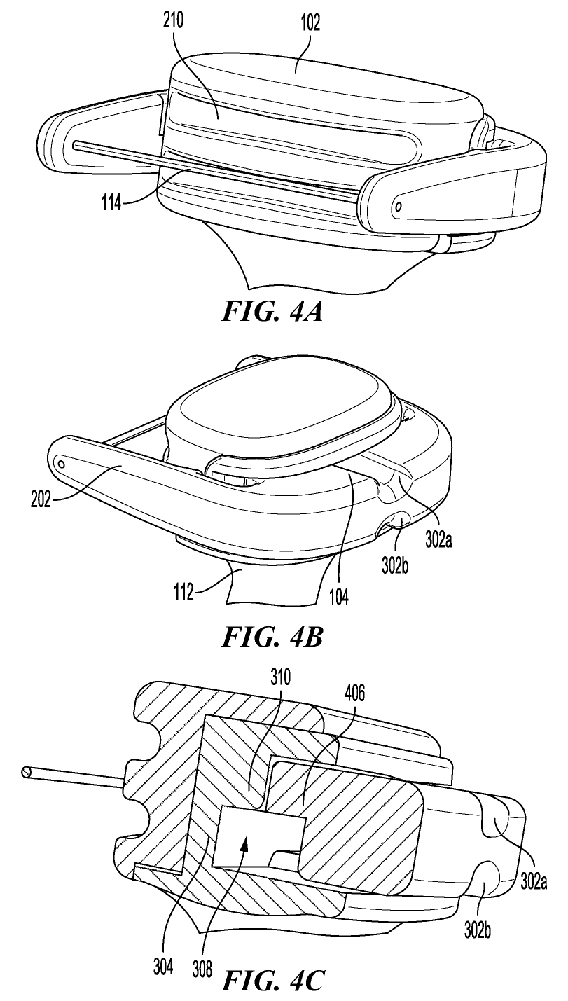

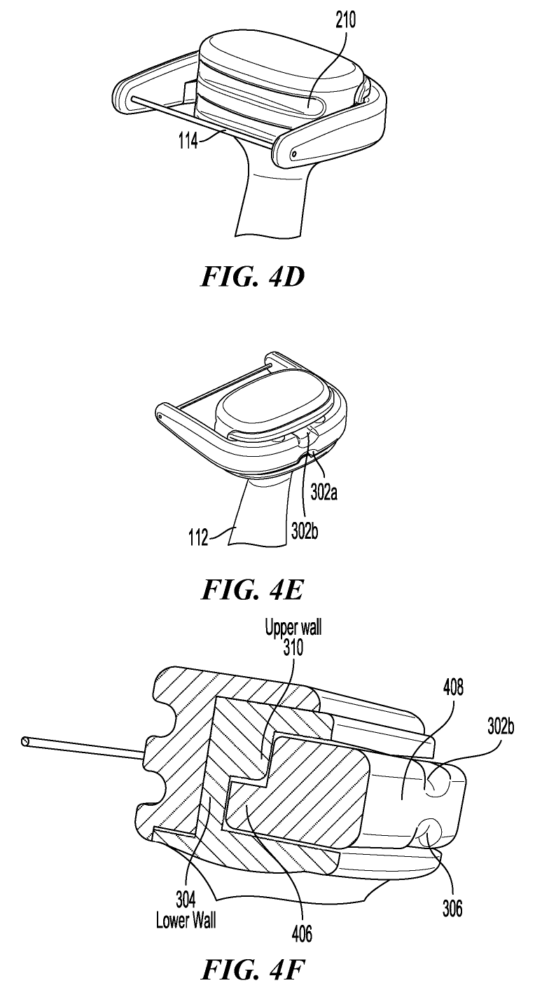

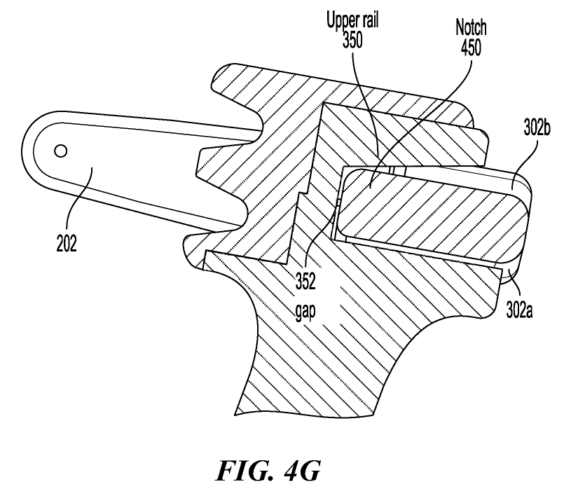

The guiding rail 306 is configured to engage with one of two corresponding flosser grooves 302a or 302b formed in the flosser head 104. Each groove 302a and 302b extends from an inner wall 300 to an outer wall that is opposite the inner wall 300, enabling dual-orientation mounting. When the first flosser groove 302a engages the guiding rail 306, the head 104 is positioned to achieve a larger floss-to-bumper offset (see FIG. 4B). When the second flosser groove 302b engages the guiding rail 306, the head 104 is positioned to achieve a smaller floss-to-bumper offset (see FIG. 4A). This male-female interaction provides lateral stabilization, preventing the flosser head 104 from rotating or wobbling during operation. This male-female interaction also ensures proper orientation, maintaining consistent alignment of the floss strand 114 beneath the bumper 102. By guiding the flosser head 104 into a repeatable position, the rail-and-groove combination enhances assembly precision and ensures secure coupling between the head and handle.

FIG. 3A also illustrates an example of the flosser head 104 with its dual-step geometry along the inner wall 300. The head includes a pair of opposing arms 202 that extend outward from its base, supporting the floss strand 114 in tension across the distal end. The two-step structure of the inner wall 300 enables the flosser head 104 to be mounted on either the upper or lower wall of the handle. When mounted using the upper wall 310, the bumper 102 is positioned closer to the floss strand 114, producing a reduced offset (for example, 3 mm) suited for baby teeth or shallow gum lines. When mounted using the lower wall 304, the bumper 102 is positioned farther from the floss strand 114, producing a larger offset (for example, 5 mm) suitable for adult teeth. Other distances are contemplated for the larger offset and the reduced offset.

The flosser head 104 may be molded as a single component or composed of multiple sections joined through insert molding, ultrasonic welding, or snap-fit assembly. In some examples, the inner wall 300 or arms 202 may include an overmolded elastomeric section to tune vibration transmission characteristics, enhance structural durability, and improve user comfort. The elastomeric section may be configured to selectively attenuate or transmit vibrational energy depending on the application, allowing for customized performance across different user profiles or dental conditions. The grooves 302a and 302b may be shaped to achieve a friction-fit or snap-fit engagement with the guiding rail 306, ensuring the head remains firmly in place during operation while still allowing for easy removal and replacement. This configuration allows a single flosser handle to support multiple head positions and user profiles without the need for additional parts, providing flexibility, safety, and longevity across a wide range of dental care needs.

The bumper 102 may be positioned at a predetermined distance above the floss strand 114 to establish a controlled floss-to-bumper offset. This offset distance may define the maximum depth to which the floss strand 114 can penetrate into the interdental space and the gingival sulcus during use. The offset distance may be measured vertically from a plane defined by the floss strand 114 to a lowermost contact surface of the bumper 102 that engages the occlusal or incisal surfaces of the teeth. In some examples, the offset distance may be approximately 3 millimeters. In other examples, the offset distance may be approximately 5 millimeters. The selection of offset distance may depend on the intended user population, with smaller offsets suited for pediatric users with primary dentition and larger offsets suited for users with permanent dentition.

The 3 millimeter offset may be achieved by configuring the step 406 on the flosser head 104 to engage the upper wall 310 of the stepped mounting interface 308. When the step 406 seats against the upper wall 310, the vertical position of the floss strand 114 relative to the bumper 102 may be fixed such that the bumper 102 extends approximately 3 millimeters above the floss strand 114. This configuration may be maintained through precise dimensional control of the step height on the flosser head 104 and the vertical spacing between the upper wall 310 and the lower wall 304 of the mounting interface 308.

The mounting interface 308 may further include an upper rail 350 positioned within a gap 352 formed in the upper wall 310. The upper rail 350 may be configured to engage a corresponding feature on the flosser head 104 when the flosser head 104 is mounted to the interface 308. The gap 352 and upper rail 350 may cooperate to reduce movement of the flosser head 104 when attached to the interface 308, providing additional stability and preventing unintended displacement during operation. The upper rail 350 may extend longitudinally along the mounting interface 308 and may be dimensioned to provide a friction fit or snap fit engagement with the flosser head 104, thereby enhancing the mechanical coupling between the flosser head 104 and the handle.

FIG. 3B illustrates an enlarged partial perspective view of the mounting interface region of the electric flosser 100, in accordance with various aspects of the present disclosure. A mounting interface 308 may be defined within the bumper 102. Within the mounting interface 308, an upper wall 310 may be positioned to form an upper interior surface of the mounting interface 308. The upper wall 310 may extend horizontally relative to the longitudinal axis of the neck 112. The upper wall 310 may define an upper boundary of a stepped cavity or recess within the mounting interface 308. The upper wall 310 may be configured to receive and support a corresponding step or projection from the flosser head 104 when the head is attached in a first orientation.

Below the upper wall 310, a lower wall 304 may be positioned to form a lower interior surface of the mounting interface 308. The lower wall 304 may extend generally parallel to the upper wall 310, though at a different vertical level, thereby creating a stepped profile within the mounting interface 308. The lower wall 304 may define a lower boundary of the stepped cavity and may be configured to receive and support a corresponding step or projection from the flosser head 104 when the head is attached in a second orientation. The vertical separation between the upper wall 310 and the lower wall 304 may determine the difference in floss-to-bumper offset distances achievable by the dual-mode mounting system.

An upper rail 350 may project outward from the upper wall 310. The upper rail 350 may be an elongated horizontal element that extends along a portion of the mounting interface 308, perpendicular to the upper wall 310. The upper rail 350 may serve as a guide or alignment feature for the flosser head 104 during attachment and may function as a mechanical stop or retention feature that engages with a corresponding groove or recess on the flosser head 104 to secure the head in place.

A gap 352 may be aligned with the upper rail 350 and may separate the upper wall 310 and the lower wall 304 into different sections. The gap 352 may be an open space or void within the mounting interface 308 that allows for the insertion and positioning of a notch defined on a step of the flosser head 104. The gap 352 may extend vertically between the underside of the upper rail 350 and the upper surface of the lower wall 304. The size and shape of the gap 352 may be selected to ensure secure engagement while allowing for easy insertion and removal of the flosser head 104.

A guiding rail 306 may be positioned adjacent to the gap 352. The guiding rail 306 may be a vertically oriented or curved feature. The guiding rail 306 may extend from the gap 352 to an edge of the mounting interface 308. The guiding rail 306 may serve to align the flosser head 104 during attachment by engaging with a corresponding groove or channel on the inner surface of the flosser head 104. The guiding rail 306 may prevent lateral movement or rotation of the flosser head 104 once attached, thereby maintaining proper alignment between the floss strand 114 and the bumper 102.

The neck 112 may extend downward from the mounting interface region, providing a structural transition to the handle of the device. The neck 112 may house internal components such as a drive shaft or vibration transmission mechanism that couples the motor in the handle to the flosser head 104. The neck 112 may be formed from a rigid polymer material to ensure efficient transmission of vibrational energy while maintaining structural integrity during use.

The spatial arrangement of the upper wall 310, lower wall 304, upper rail 350, gap 352, and guiding rail 306 may create a stepped mounting interface that allows the flosser head 104 to be attached in two distinct orientations. In a first orientation, a step on the flosser head 104 may engage with the upper wall 310, positioning the bumper 102 at a first distance from the floss strand 114. In a second orientation, the step on the flosser head 104 may engage with the lower wall 304, positioning the bumper 102 at a second, greater distance from the floss strand 114. This dual-mode capability may enable a single flosser head 104 to be used with different floss-to-bumper offsets, accommodating users with different dental anatomies or developmental stages.

The upper rail 350, gap 352, and guiding rail 306 may work in conjunction to ensure proper alignment and secure retention of the flosser head 104 in either orientation. The upper rail 350 may engage with a corresponding groove on the flosser head 104, while the guiding rail 306 may engage with a lateral groove or channel, thereby preventing unwanted movement in multiple directions.

The materials used for the mounting interface components may be selected to provide durability and resistance to wear. The upper wall 310, lower wall 304, upper rail 350, and guiding rail 306 may be integrally molded as part of the bumper 102 or may be formed as separate components that are assembled into the mounting interface 308. The surfaces of these components may be smooth to facilitate easy insertion and removal of the flosser head 104, while also providing sufficient friction to maintain secure attachment during operation.

FIGS. 4A, 4B, 4C, 4D, 4E, and 4G collectively illustrate the two mounting configurations of the flosser head 104 and handle of the electric flosser 100 in accordance with various aspects of the present disclosure. For ease of explanation, not every component shown in earlier figures is labeled in FIGS. 4A, 4B, 4C, 4D, 4E, and 4G.

FIG. 4A illustrates the flosser head 104 mounted in a first orientation that produces a reduced offset—such as a 3 mm distance—between the bumper 102 and the floss strand 114. The flosser head 104 includes a pair of arms 202 extending from its base and supporting the floss strand 114, while the bumper 102 is positioned above the floss strand 114 to serve as a protective stop. This first configuration may be designed for users with baby teeth or smaller oral geometries, where a shallower flossing depth helps prevent gum irritation or injury.

FIG. 4B illustrates engagement detail of the first orientation, in accordance with various aspects of the present disclosure. When the second flosser groove 302b engages the guiding rail of the handle, the head 104 is seated in the upper position of the interface, thereby positioning the bumper 102 closer to the floss strand 114. In this reduced-offset configuration, the bumper 102 rests approximately 3 mm away from the flossing plane, ensuring that the floss strand 114 reaches only a limited depth between adjacent teeth. During use, the bumper 102 contacts the occlusal or incisal surfaces of the teeth, acting as a mechanical stop that prevents the floss strand 114 from being pushed too far into the gum line. This arrangement provides a gentle flossing action that is ideal for children with primary dentition, where gums are more sensitive and less tolerant of deep insertion forces. The dual-step geometry of the handle and head ensures stable, repeatable assembly while allowing users or caregivers to easily select the appropriate flossing depth.

FIG. 4C illustrates a partial cross-sectional view of the flosser head 104 in the first orientation, in accordance with various aspects of the present disclosure. The step 406 formed on the inner wall 300 engages with the upper wall 310 of the dual-level mounting interface 308. Below the upper wall 310, the lower wall 304 defines a second engagement surface that remains unengaged in this first orientation. The mechanical interlock formed by the step 406, the upper wall 310, and the guiding rail 306 (not shown in FIG. 4C) may resist both axial and lateral forces, ensuring that the flosser head 104 remains securely attached during the reciprocating motion of the floss strand 114.

FIG. 4D illustrates the flosser head 104 in an alternate orientation (e.g., second orientation), producing an increased offset—such as a 5 mm distance—between the bumper 102 and the floss strand 114. This configuration may be intended for users with adult teeth, which generally require deeper interdental cleaning due to larger tooth spacing. In this arrangement, the first flosser groove 302a engages with the guiding rail 306 of the mounting interface 308.

FIG. 4E illustrates a perspective view of the flosser head 104 in the second orientation, in accordance with various aspects of the present disclosure. The guiding rail 306 may be configured as a male protrusion on the handle that engages with female grooves 302a and 302b on the flosser head 104, or alternatively, the guiding rail 306 may be configured as a female channel on the handle that receives male protrusions formed on the flosser head 104.

FIG. 4F illustrates a partial cross-sectional view of the flosser head 104 in the second orientation, in accordance with various aspects of the present disclosure. The step 406 of the flosser head 104 engages within a cavity defined by the upper wall 310 and the lower wall 304, forming a stable coupling that maintains structural integrity during operation. The first flosser groove 302a may engage with the guiding rail 306. The guiding rail 306 may serve as both an alignment feature during insertion and a retention feature that resists vertical separation forces during operation. This engagement results in the increased offset between the bumper 102 and the floss strand 114. The mechanical interlock formed by the step 406, the lower wall 304, and the guiding rail 306 may resist both axial and lateral forces, ensuring that the flosser head 104 remains securely attached during the reciprocating motion of the floss strand 114. Users or caregivers can easily reverse the orientation of the flosser head 104 to switch between the different offsets without tools or adjustments.

FIG. 4G illustrates a detailed view of the notch fitting into the gap 352 in the second orientation described with reference to FIGS. 4D, 4E, and 4F, in accordance with various aspects of the present disclosure. The notch may be defined on the step 406 of the flosser head 104 and may be configured to align with and insert into the gap 352 when the flosser head 104 is mounted in the second orientation. The gap 352 may be positioned between the upper wall 310 and the lower wall 304, providing a clearance space that receives the notch 450. The engagement of the notch within the gap 352 may provide additional mechanical stability and may prevent rotation or lateral movement of the flosser head 104 during operation. The notch and gap 352 may form a complementary fit that ensures proper alignment and seating of the flosser head 104 in the lower portion of the mounting interface 308. This configuration may maintain the increased offset between the bumper 102 and the floss strand 114 while providing secure attachment during the reciprocating motion of the floss strand 114.

As illustrated in FIGS. 4A-4G, the dual-step system enables both shallow and deep flossing configurations using the same flosser head and handle design. This approach provides flexibility and adaptability as users’ dental needs change, such as a child transitioning from primary to permanent teeth, while maintaining the protective function of the bumper 102 and the ergonomic benefits of the electric flosser 100.

In some examples, depth adjustability may be provided by a repositionable bumper 102 in addition to, or alternate from, mounting the flosser head 104 in multiple orientations. In some examples, the flosser head 104 may be configured for attachment to the handle in a single mounting position. In such examples, the bumper 102 may be removably coupled to the handle or another portion of the electric flosser 100 and may be selectively positionable in a first bumper position or a second bumper position. The first bumper position may place the bumper 102 a first distance from the floss strand 114, and the second bumper position may place the bumper 102 a second distance from the floss strand 114. The second distance may be greater than the first distance to permit a deeper flossing position when desired.

In some examples, the bumper 102 includes one or more notches, grooves, steps, tabs, rails, or stop features that cooperate with corresponding structures on the handle 108, neck 112, or another support portion of the electric flosser 100. The cooperating features may guide insertion of the bumper 102 into a selected position and may retain the bumper 102 during use. For example, a notch of the bumper 102 may align with a gap, rail, or shoulder of the handle 108 in a manner similar to the alignment and retention features described above for the flosser head 104. A first stop surface may define a first installed position corresponding to a shallower flossing depth, and a second stop surface may define a second installed position corresponding to a deeper flossing depth. The selected stop position may determine the offset between the bumper 102 and the floss strand 114.

In some examples, the bumper 102 can be removed and reattached in a different position by a user or caregiver without tools. This arrangement may allow a single disposable flosser head 104 configuration to be used with multiple depth settings. Such a configuration may be useful where the floss head geometry remains fixed and the desired depth adjustment is achieved through repositioning of the bumper 102. In this manner, the adjustable relationship between the bumper 102 and the floss strand 114 may be established by the head mounting geometry, the bumper mounting geometry, or a combination of both.

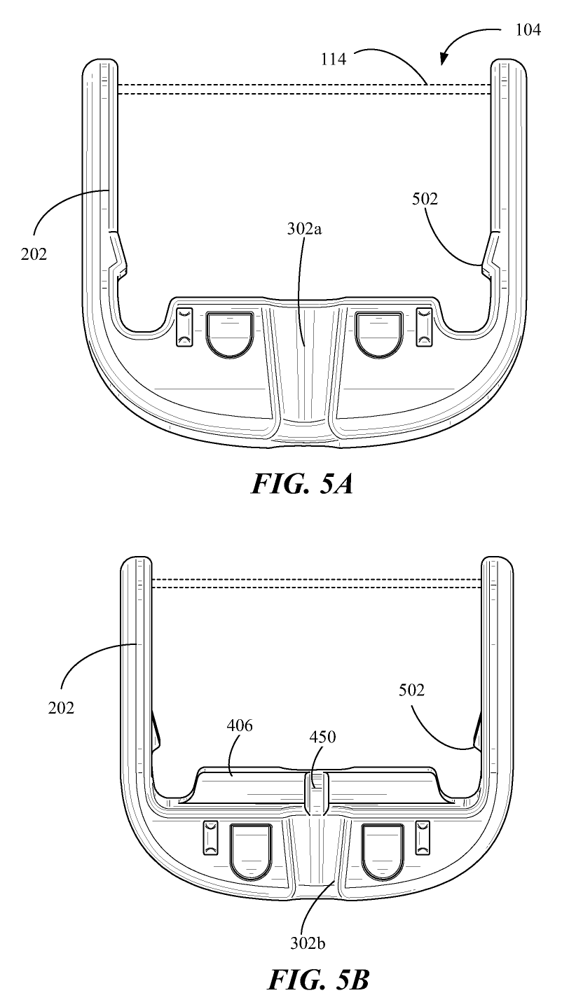

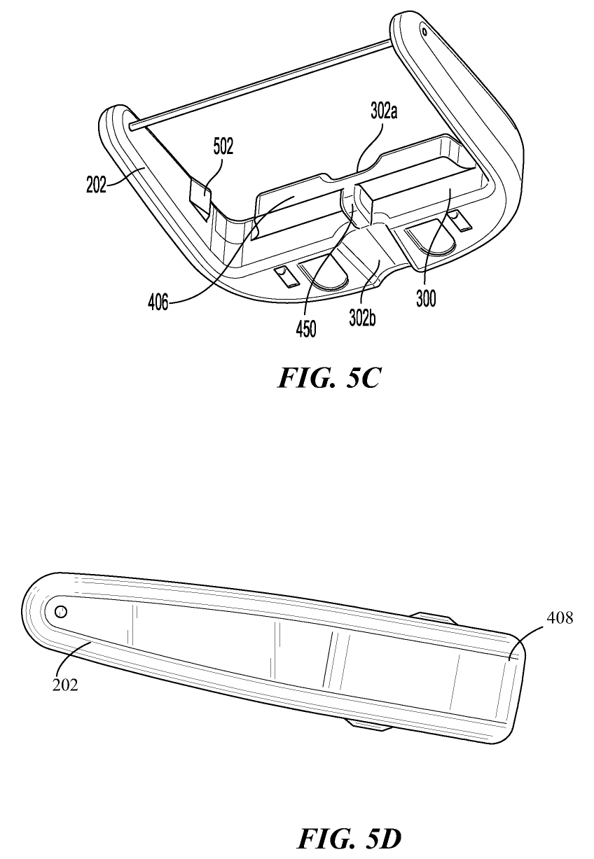

FIGS. 5A, 5B, 5C, and 5D illustrate various views of the flosser head 104, in accordance with various aspects of the present disclosure. For ease of explanation, not every feature from prior figures is labeled in FIGS. 5A, 5B, 5C, and 5D. The flosser head 104 may be compatible with different orientations, such as 3 mm and 5 mm mounting orientations, described with reference to FIGS. 4A-4G.

FIG. 5A illustrates a top-down view of the flosser head 104, in accordance with various aspects of the present disclosure. The flosser head 104 features a generally U-shaped frame that includes a pair of opposing arms 202 extending outward from a central base portion. A floss strand 114 is tensioned between the distal ends of the arms 202, forming an open region that facilitates insertion between teeth during flossing. The floss strand 114 may be formed from a monofilament, multifilament, or ribbon-style dental floss and may optionally include coatings such as wax or fluoride. In some examples, the floss may be flavored to encourage consistent use among children. The arms 202 are relatively broad and robust, providing structural strength and resistance to deformation during use. The geometry of the arms 202 also contributes to proper floss tensioning and ensures that the floss strand 114 maintains a consistent position when oscillated or vibrated by the electric motor.

FIG. 5B illustrates a bottom-up view of the flosser head 104, in accordance with various aspects of the present disclosure. The inner surface of the flosser head 104 includes a step 406 extending from an inner wall toward the base of the head. This step 406 interacts with the stepped mounting interface of the handle, as described previously, allowing the head to be positioned in either a high or low configuration to achieve different floss-to-bumper offsets. The first flosser groove 302a and second flosser groove 302b, positioned on opposing sides of the step 406, enable dual-orientation attachment to the handle’s guiding rail. In this manner, the same head can be used for both the reduced-offset (3 mm) configuration and the increased-offset (5 mm) configuration, supporting pediatric and adult flossing modes without requiring different components. A notch 450 may be defined on the step 406 and may be configured to align with and insert into the gap 352 of the mounting interface 308 when the flosser head 104 is mounted in the second orientation. The notch 450 may provide additional mechanical stability by engaging with the gap 352, preventing rotation or lateral movement of the flosser head 104 during operation. The notch 450 may be positioned centrally on the step 406 or offset to one side, depending on the desired alignment and retention characteristics.

FIG. 5C illustrates a perspective view of the flosser head 104, in accordance with various aspects of the present disclosure. The step 406 may be visible extending from the inner wall 300 of the flosser head 104. The step 406 may define a horizontal or angled surface that engages with the upper wall 310 or lower wall 304 of the mounting interface 308, depending on the selected orientation. The notch 450 may be visible on the step 406 and may be configured as a recess or cutout that aligns with the gap 352 when the flosser head 104 is mounted in the second orientation. The notch 450 may have a rectangular, trapezoidal, or curved profile that complements the geometry of the gap 352. A notch 502 may be formed near the inner junction of one or both arms 202. The notch 502 may serve as a guide or alignment feature, assisting in proper engagement with the mounting interface or facilitating manufacturing processes such as overmolding or assembly. The outer wall 408 of the flosser head 104 may provide additional structural integrity and may also define the interface that mates with the bumper structure when assembled. The head 104 may include the first flosser groove 302a and the second flosser groove 302b, one of which engages the guiding rail of the handle during attachment. This dual-groove configuration may ensure that the head 104 can be reversibly mounted while maintaining the same mechanical fit and lateral stability in either orientation.

FIG. 5D illustrates a side view of the flosser head 104, in accordance with various aspects of the present disclosure. The flosser head 104 may be constructed as a single molded component or as a multi-material assembly combining a rigid polymer frame and an elastomeric overmold for improved comfort and vibration damping. In some examples, the arms 202 may include textured or contoured surfaces to improve grip during cleaning or replacement. The modular nature of the flosser head 104 allows it to be replaced periodically for hygiene purposes while the handle and bumper assembly remain reusable, promoting both safety and sustainability in daily oral care routines.

While the standard flosser head 104 described with reference to FIGS. 2, 4A - 4G, and 5A-5D is suitable for general flossing applications, certain users may require specialized head configurations. For example, individuals wearing orthodontic braces face unique challenges during flossing, as traditional floss heads with broad arms may not fit between the brackets and wires affixed to the teeth. To address this need, an orthodontic flosser head 600 may be provided as an alternative to the standard flosser head 104.

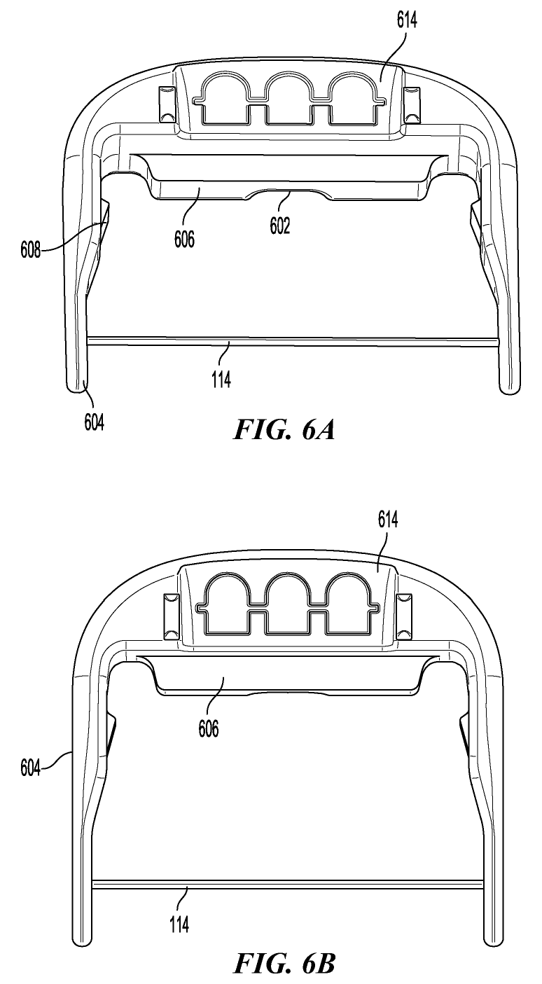

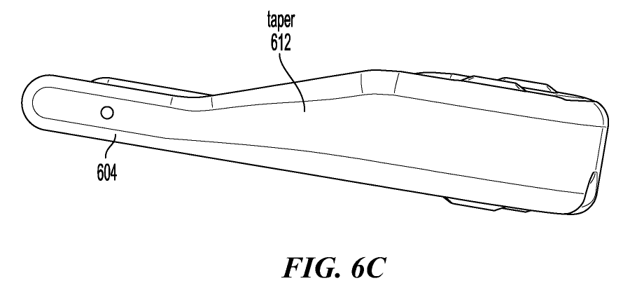

FIGS. 6A, 6B, and 6C illustrate an example of an orthodontic flosser head 600 in accordance with various aspects of the present disclosure. For ease of explanation, not every element from the earlier figures is labeled in FIGS. 6A, 6B, and 6C. The orthodontic floss head 600 is designed specifically for users with orthodontic appliances such as braces, brackets, or archwires, where conventional floss heads may not easily reach interdental spaces. The orthodontic floss head 600 features a narrow, U-shaped frame that includes a pair of arms 604 extending from a central base portion 608. The arms 604 are tapered and slender, allowing them to navigate tight and irregular spaces around orthodontic hardware without snagging. This configuration improves user control and comfort while enabling precise cleaning between teeth and around brackets.

A floss strand 114 is tensioned between the distal ends of the arms 604. The floss strand 114 may be a thin or coated monofilament engineered to pass easily between teeth and under archwires. The positioning of the floss strand 114 enables effective plaque removal between teeth while keeping the flosser head 600 outside the bracket line, reducing interference with orthodontic components. Internally, the flosser head 600 includes a groove 602 and step 606 formed along the inner surface of the base portion 608. The step 606 is configured to engage with the dual-step mounting interface of the flosser handle, similar to the configurations described for earlier figures. This interface allows for secure, repeatable mounting of the orthodontic floss head 600 to the handle.

In some examples, the orthodontic floss head 600 may be configured to support only the reduced-offset mode (for example, 3 mm) to provide gentle flossing and minimize gum irritation for orthodontic patients. In other examples, the orthodontic floss head 600 may include both an upper groove and a lower groove (e.g., similar to grooves 302a and 302b of the standard flosser head), thereby supporting both 3 mm and 5 mm offsets for different user needs. The presence of multiple grooves allows the orthodontic head 600 to adapt to varying tooth and bracket geometries while maintaining safe floss-to-bumper spacing. In other examples, the orthodontic floss head 600 may be configured to support only the increased-offset mode (for example, 5 mm). In such examples, the step 606 may be positioned or dimensioned in accordance with the configuration of the mounting interface 308 described with reference to FIG. 3. For instance, in some configurations, the upper wall 310 may extend beyond the lower wall 304 toward the opening of the interface (e.g., opposite a wall 210 of the bumper 102), or vice versa. Different orthodontic floss heads 600 may be specified to support either configuration of the mounting interface 308. More specifically, the step 606 may be located adjacent to a bottom end (not shown in FIG. 6) opposite a top end 614, or, in other configurations, the step 606 may instead be located adjacent to the top end 614. This structural flexibility allows the orthodontic floss head 600 to accommodate variations in mounting interface geometry to support either a reduced-offset mode (e.g., 3 mm) or an increased-offset mode (e.g., 5 mm).

The examples of FIGS. 6A, 6B, and 6C show that the orthodontic floss head 600 retains the overall U-shaped geometry of the standard flosser head but features narrower and more streamlined dimensions. As shown in the side view of FIG. 6C, each arm 604 includes a taper 612 that gradually reduces the cross-sectional thickness from the base toward the distal end. This tapering provides flexibility and improved access to tight areas while maintaining sufficient strength for repeated use. The reduced width of the arms 604 also minimizes obstruction and allows the floss strand 114 to move freely beneath orthodontic wires or between crowded teeth.

In some examples, one or both arms 604 may include a widened portion positioned along the length of the arm 604 and configured to contact an orthodontic wire during use. The widened portion may have a transverse dimension selected to engage the wire before the floss strand 114 is advanced beyond a desired depth. Contact between the widened portion and the orthodontic wire may thereby limit insertion depth of the orthodontic floss head 600 relative to the teeth and gingiva. In some examples, the widened portion may provide a depth-control feature in place of the bumper 102. In other examples, the widened portion may cooperate with the bumper 102 so that both structures contribute to limiting insertion depth. The widened portion may be positioned closer to the distal end than the base portion 608 so that the depth-limiting contact occurs adjacent to the orthodontic appliance while the floss strand 114 remains positioned for cleaning between adjacent teeth.

In some examples, the widened portion may be formed as a local increase in width, thickness, or both, relative to adjacent portions of the arm 604. The widened portion may extend along one arm 604 or both arms 604. The widened portion may be symmetrical or asymmetrical, depending on the intended engagement with a bracket wire or other orthodontic structure. This arrangement may allow the orthodontic floss head 600 to establish a controlled flossing depth based on engagement with the orthodontic appliance itself.

The orthodontic floss head 600 may be fabricated from a durable yet slightly flexible polymer material, such as nylon, acetal, or a reinforced thermoplastic elastomer, that withstands repeated bending and cleaning cycles. In some examples, portions of the base 608 or arms 604 may be overmolded with a softer elastomeric layer to enhance comfort and prevent accidental contact with sensitive gum tissue or bracket edges. Collectively, the orthodontic floss head 600 provides a user-friendly and effective solution for individuals with braces, maintaining consistent floss tension and reach while preventing damage to orthodontic hardware.

In some examples, the orthodontic floss head 600 may also include structural features that limit the insertion depth of the arms 604 or floss strand 114 to prevent over-penetration into the gum line. For example, one or both arms 604 may incorporate a localized ridge or shoulder that makes contact with the tooth surface when the floss strand 114 reaches an intended depth. Such a design may provide a partial stopping effect for additional safety. However, these arm-based limits generally provide only localized or inconsistent control and may not offer the same comfort or predictability as the dedicated bumper 102. The bumper configuration described throughout this disclosure remains the preferred approach for maintaining consistent, user-friendly protection, as it provides a continuous and tactile stopping surface that effectively prevents excessive gum engagement.

As illustrated in FIGS. 5A, 5B, 5C, and 5D, as well as FIGS. 6A, 6B, and 6C, both the standard flosser head 104 and the orthodontic flosser head 600 include notches 502 and 608, respectively, that assist in securing the head to the bumper structure of the electric flosser. In FIGS. 5A, 5B, 5C, and 5D, the flosser head 104 includes a notch 502 formed near the inner junction of one or both arms 202. In FIGS. 6A, 6B, and 6C, the orthodontic flosser head 600 includes a corresponding notch 608 located in a similar position along the inner surface of one or both arms 604.

Each notch 502 and 608 extends outward from the respective arms 202 and 604. Additionally, each notch 502 and 608 is formed as a partial projection that originates from a lower surface or plane of a respective arm 202 and 604 and extends upward to approximately the midpoint of the arm’s thickness along its horizontal plane. This geometry provides sufficient engagement with a complementary feature of the mounting interface, which is adjacent to the bumper, to retain the flosser head securely, while minimizing excess bulk or interference with the user’s line of sight and access. Each notch 502 and 608 may be rigid or flexible.

As discussed, when the flosser head is mounted to the handle, each notch 502 or 608 may engage with a complementary feature of the mounting interface that extends outward from the bumper 102. This engagement helps retain the flosser head in position during use, ensuring stable mechanical coupling and preventing unintentional detachment. The specific geometry of the notch allows it to interact with different features on the bumper depending on which head is used—such as a protrusion, ridge, or recessed lip formed on the bumper surface.

In some examples, the engagement between the notch and the bumper feature may create a slight snap-fit or frictional interference that reinforces the secure attachment of the flosser head without the need for additional fasteners. This interaction not only stabilizes the head during vibration or oscillation but also provides consistent alignment between the floss strand and the bumper, maintaining the designed floss-to-bumper offset whether the user employs the standard flosser head 104 or the orthodontic flosser head 600.

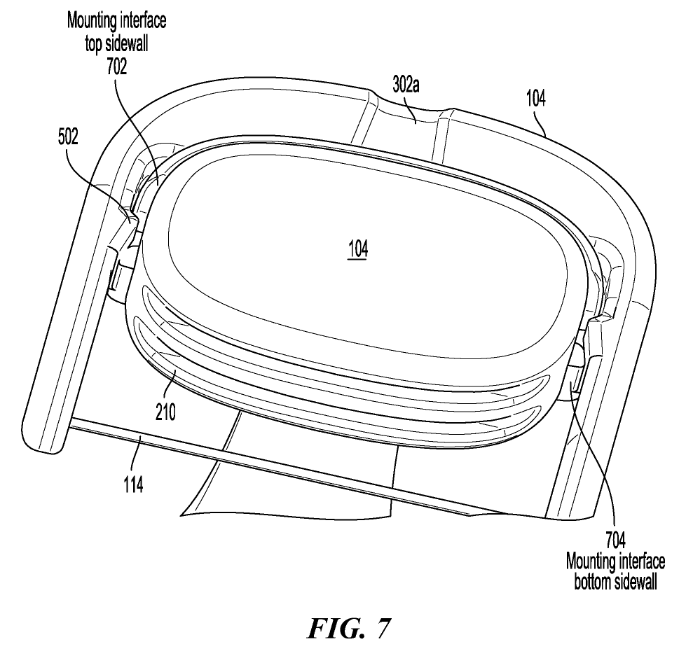

FIG. 7 illustrates an enlarged view of the flosser head 104 mounted to the mounting interface, in accordance with various aspects of the present disclosure. As shown, each notch 502 located on a respective arm 202 of the flosser head engages with a top sidewall 702 of the mounting interface. As discussed, an upper wall and lower wall of the mounting interface may partially extend to each side of the bumper 102. The respective extended portions of the upper wall and lower wall form the top sidewalls 702 and bottom sidewalls 704. The top sidewalls 702 and bottom sidewalls 704 form interfaces for engaging the notches 502 of the head 104 (or the notches 608 of the head 600). That is, these sidewalls 702 and 704 form opposing boundaries that guide and retain the flosser head 104 when coupled to the mounting interface.

As shown in the example of FIG. 7, the notches 502 function as a partial locking feature that cooperates with the respective pair of sidewalls 702 and 704 to resist axial and lateral movement of the flosser head 104. This engagement prevents the flosser head 104 from detaching unintentionally during operation, particularly when the device is vibrating or when the user applies pressure during flossing. Depending on the head used, such as the standard flosser head 104 or the orthodontic flosser head 600, the corresponding notch 502 or 608 may engage with different sidewalls 702 and 704, such as the top sidewall 702 or the bottom sidewall 704. For example, the head 104 may engage with one pair of sidewalls 702 or 704 based on the orientation of the head 104 with respect to the mounting interface.

The disclosed electric flosser provides a solution for safe, effective, and independent flossing for children and adults. Aspects of the present disclosure bridge the gap between manual flossers that may be difficult for children to maneuver and bulky, water-based flossing systems that can be messy and intimidating. As discussed, the flosser includes an elongated handle with a soft-touch grip sized for a child’s hand, and a removable battery cap that houses a replaceable AA battery. The user activates the device via an on/off button, which powers an internal motor configured to deliver ultrasonic vibration at selectable speeds, such as approximately 5,000 strokes per minute or approximately 10,400 strokes per minute, to the floss head. This vibration improves the effectiveness of flossing by loosening plaque and dislodging food particles between the teeth and near the gumline.

A replaceable floss head may securely attach to a mounting interface of the handle via a snap-on/snap-off mounting mechanism. The floss head may include flavored, tensioned floss stretched between a pair of opposing arms. The head is designed to accommodate two floss-to-bumper offsets, for example, 3 mm and 5 mm, based on the orientation in which it is attached. This is enabled through a dual-step geometry in both the handle and the head. When mounted in one orientation, the head engages the upper wall of the stepped interface to provide a 3 mm offset (for baby teeth). When flipped and mounted in the opposite orientation, the head engages the lower wall to provide a 5 mm offset (for adult teeth).

The handle also includes a soft bumper, which acts as a stop against the top of the teeth. This prevents the floss from being forced too far into the gums, reducing the risk of injury and making the device especially safe for young users. The bumper, in combination with the ultrasonic action and depth-limiting mounting design, ensures effective yet gentle flossing.

Two floss head designs are provided: a standard head for general use and an orthodontic head for children with braces. The orthodontic version features thin, tapered arms that narrow from a wide base to a slender distal end, allowing the floss head to pass easily between teeth and around orthodontic wires and brackets. Both head types are compatible with the dual-mode offset system, allowing families to use a single handle across multiple developmental stages or oral care needs.

In some examples, the flosser includes a rechargeable battery with a charging port or base, a light-up or musical variant to encourage compliance, or versions with digital timers or pressure sensors to guide users through proper flossing duration and technique. The bumper may be constructed from a variety of biocompatible, flexible materials such as thermoplastic elastomers or silicone. Additional floss head types may be developed for specialized dental needs or to accommodate even narrower interdental spacing. The system may also be adapted to include a disposable cartridge system for hygiene-sensitive environments.

In some examples, a process for using the electric flosser may begin by selecting an appropriate floss head, such as a normal head for general use or an orthodontic head for users with braces. The user then determines the desired floss-to-bumper offset based on the type of teeth (e.g., 3 mm for baby teeth or 5 mm for adult teeth) and orients the floss head accordingly. The offsets of 3 mm and 5 mm are exemplary offsets. Aspects of the present disclosure are not limited to these offsets, and other offsets are contemplated. The flosser head is then attached to the handle by aligning the step on the inner wall of the head with either the upper or lower wall of the stepped mounting interface on the handle. The head is then pressed into place until it snaps securely onto the handle.

Once the flosser head is attached, the user powers on the device by pressing the on/off button located on the handle. This activates the ultrasonic motor, which may deliver vibrational energy at a selectable rate, such as approximately 5,000 strokes per minute or approximately 10,400 strokes per minute, to the floss strand, enhancing plaque removal and cleaning efficiency. The user then inserts the floss strand between two adjacent teeth, ensuring that the bumper contacts the top surfaces of the teeth. The bumper acts as a physical stop, preventing the floss from being forced too deeply into the gums. Using a gentle motion, the user glides the floss strand up and down along the sides of each tooth, allowing the ultrasonic action to dislodge plaque and food particles.

For users with braces, the orthodontic head’s tapered arms allow the floss strand to access tight spaces between teeth and orthodontic wires or brackets. The user may move the flosser from one tooth to the next, repeating the process throughout the upper and lower arches of the mouth.

After flossing is complete, the user turns off the device and may remove the floss head by pulling it away from the handle using the snap-off mechanism. The flosser may then be cleaned and stored for future use. The floss head may be discarded or replaced as needed, depending on wear or hygiene preferences.

Aspects of the present disclosure are not limited to electric flossers. In some examples, the disclosed head and bumper configurations, mounting interfaces, and adjustable offset features may also be applied to manual flossers or hybrid designs that operate without an electric motor. These manual implementations may include similar interchangeable heads, bumpers, or dual-step engagement systems to provide the same benefits of safety, comfort, and adaptability described herein.

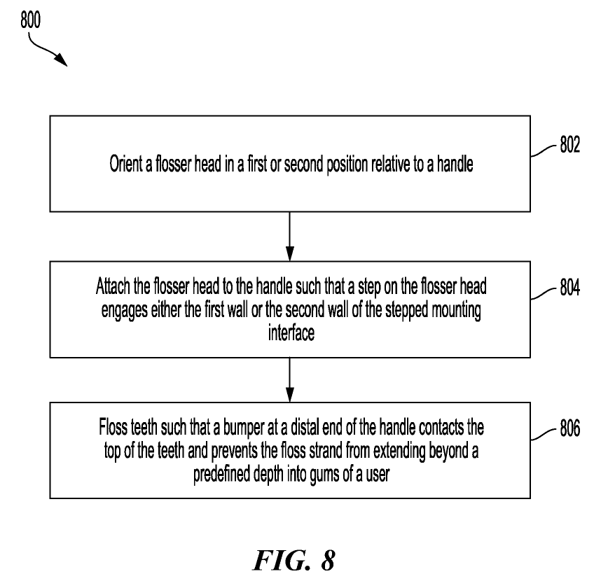

FIG. 8 is a flow diagram illustrating an example of a process 800 for using a flosser in accordance with various aspects of the present disclosure. The flosser may include a standard flosser head 104 as described with reference to FIG. 5 or an orthodontic floss head 600 as described with reference to FIGS. 6A, 6B, and 6C. The process 800 may be performed by a user and applies to both electric and manual implementations of the flosser.

The process 800 begins at block 802, where the user orients the flosser head in either a first or second position relative to a handle of the flosser. The handle may include a stepped mounting interface having a first wall and a second wall arranged vertically with respect to one another. In one example, the first wall may be an upper wall, and the second wall may be a lower wall of the stepped mounting interface. The orientation of the flosser head determines the position of the floss strand relative to a bumper located at the distal end of the handle. The flosser head may include a pair of opposing arms and a floss strand tensioned therebetween. In some examples, the selected flosser head may be an orthodontic head having arms (see FIG. 6) that taper from a wide base to a narrow distal end to better navigate around braces or other orthodontic hardware. In other examples, the user may select a standard flosser head (see FIG. 5) configured for general use, with arms designed to maintain consistent floss tension and durability.

At block 804, the user attaches the flosser head to the handle such that a step on the flosser head engages either the first wall or the second wall of the stepped mounting interface. In some examples, engaging the first wall positions the bumper approximately 3 millimeters above the floss strand, which may be suited for baby teeth or smaller oral geometries. In other examples, engaging the second wall positions the bumper approximately 5 millimeters above the floss strand, which may be desirable for adult teeth that require deeper interdental cleaning. In certain configurations, the first wall may extend horizontally beyond the second wall toward the opening of the stepped mounting interface to provide improved engagement and retention of the flosser head.

At block 806, the user flosses their teeth such that the bumper at the distal end of the handle contacts the top surfaces of the teeth and prevents the floss strand from extending beyond a predefined depth into the gums. When the flosser is an electric model, the method may further include activating a motor housed within the handle to vibrate the floss strand. In some examples, the motor may be configured to vibrate the floss strand at a selectable frequency, such as approximately 5,000 strokes per minute or approximately 10,400 strokes per minute, allowing for enhanced plaque removal while maintaining gentle gum contact. The vibration, combined with the bumper’s stopping action, enables effective flossing without risk of gum injury.

After flossing, the user may remove the flosser head via a snap-on/snap-off connection and replace it with a new or different head, such as an orthodontic head or a fresh standard head. This modular arrangement allows for convenient maintenance, hygiene, and adaptability across different users or dental care routines while ensuring consistent safety and comfort through the controlled floss-to-bumper spacing.

The electric flosser 100 and its associated flosser heads 104 and 600 may be manufactured through a series of molding, assembly, and finishing operations. The manufacturing process may involve forming individual components from various materials and subsequently assembling those components into functional subassemblies and final products. The following description outlines exemplary manufacturing methods for producing the flosser handle, the standard flosser head 104, and the orthodontic flosser head 600.

The handle 108 of the electric flosser 100 may be formed through injection molding of a thermoplastic material such as acrylonitrile butadiene styrene (ABS) or polycarbonate. A mold cavity may be prepared with the desired contours and features of the handle 108. Molten plastic may be injected into the mold cavity under pressure. The plastic may be allowed to cool and solidify within the mold. The solidified handle 108 may be ejected from the mold. The handle 108 may include internal features such as mounting bosses, screw posts, or snap-fit features for securing internal components.

The soft-touch grip regions of the handle 108 may be formed through an overmolding process. The previously molded handle 108 may be placed into a second mold cavity. A thermoplastic elastomer (TPE) or similar compliant material may be injected over selected regions of the handle 108. The TPE may bond to the underlying handle material during the molding process. The overmolded handle 108 may be removed from the mold after cooling. The overmolded regions may provide enhanced grip and tactile feedback for the user.

The neck 112 may be formed integrally with the handle 108 during the initial injection molding operation. Alternatively, the neck 112 may be molded as a separate component and subsequently attached to the handle 108 through ultrasonic welding, adhesive bonding, or mechanical fastening. The neck 112 may include internal passages or channels for routing electrical connections or mechanical linkages between the handle 108 and the flosser head 104.

The bumper 102 may be molded from a compliant material such as silicone or thermoplastic elastomer. A compression molding or injection molding process may be used to form the bumper 102. The bumper 102 may be molded as a separate component and subsequently attached to the mounting interface 308. Alternatively, the bumper 102 may be overmolded directly onto the mounting interface 308 in a multi-shot molding operation. The bumper 102 may include integral features such as alignment ribs, detent tabs, or snap-fit couplings that engage with corresponding features on the mounting interface 308.

The mounting interface 308 may be formed as part of the neck 112 or as a separate component attached to the distal end of the neck 112. The mounting interface 308 may include the upper wall 310, the lower wall 304, the guiding rail 306, the upper rail 350, and the gap 352. These features may be formed directly during the injection molding process through the use of appropriately shaped mold cores and cavities. The mounting interface 308 may be designed to provide precise dimensional control to ensure proper engagement with the flosser head 104 in both the first and second orientations.

The motor and associated drive components may be assembled into the handle 108 after molding. The motor may be secured within an internal cavity of the handle 108 using mounting brackets, adhesive, or snap-fit features. Electrical connections may be routed from the motor to the on/off button 106 and to the power supply compartment. The battery cap 110 may be molded separately and attached to the base of the handle 108 through a threaded connection, snap-fit mechanism, or bayonet-style coupling. The battery cap 110 may include a seal or gasket to provide moisture resistance.

The standard flosser head 104 may be manufactured through injection molding of a rigid thermoplastic material such as ABS, polycarbonate, or nylon. A mold cavity may be prepared with the geometry of the flosser head 104, including the arms 202, the inner wall 300, the step 406, the first flosser groove 302a, the second flosser groove 302b, and the notches 502. Molten plastic may be injected into the mold cavity. The plastic may be allowed to cool and solidify. The molded flosser head 104 may be ejected from the mold.

The floss strand 114 may be installed onto the flosser head 104 after molding. The floss strand 114 may be threaded through holes or slots formed in the distal ends of the arms 202. The floss strand 114 may be tensioned to a predetermined level. The ends of the floss strand 114 may be secured through knotting, heat staking, adhesive bonding, or mechanical clamping. The floss strand 114 may be a monofilament or multifilament dental floss. The floss strand 114 may be coated with wax, fluoride, or flavoring agents.

In some examples, the flosser head 104 may be manufactured through a multi-material molding process. A first shot of rigid plastic may form the structural frame of the flosser head 104. A second shot of a softer elastomeric material may be overmolded onto selected regions of the flosser head 104 to provide cushioning or grip enhancement. The overmolded regions may be positioned on the arms 202 or on the inner wall 300.

The notches 502 may be formed integrally with the arms 202 during the injection molding process. The notches 502 may project outward from the lower surface of the arms 202. The notches 502 may be dimensioned to engage with the top sidewalls 702 or bottom sidewalls 704 of the mounting interface 308. The notches 502 may provide a snap-fit or friction-fit engagement that secures the flosser head 104 to the handle during operation.

The orthodontic flosser head 600 may be manufactured through a similar injection molding process as the standard flosser head 104. The mold cavity for the orthodontic flosser head 600 may be designed to produce the narrower, tapered arms 604. The taper 612 may be formed directly in the mold geometry. The base portion 608 may include the groove 602 and the step 606. The step 606 may be positioned to engage with either the upper wall 310 or the lower wall 304 of the mounting interface 308, depending on the desired offset configuration.

The floss strand 114 may be installed onto the orthodontic flosser head 600 in the same manner as described for the standard flosser head 104. The floss strand 114 may be threaded through holes or slots in the distal ends of the arms 604. The floss strand 114 may be tensioned and secured. The orthodontic flosser head 600 may use a thinner or more flexible floss strand 114 to facilitate passage between orthodontic brackets and archwires.

The notches 608 may be formed integrally with the arms 604 during the injection molding process. The notches 608 may be dimensioned and positioned similarly to the notches 502 of the standard flosser head 104. The notches 608 may engage with the top sidewalls 702 or bottom sidewalls 704 of the mounting interface 308 to secure the orthodontic flosser head 600 to the handle.

After the individual components have been manufactured, the electric flosser 100 may be assembled. The motor may be installed into the handle 108. Electrical connections may be made between the motor, the on/off button 106, and the power supply compartment. The battery cap 110 may be attached to the base of the handle 108. The bumper 102 may be attached to the mounting interface 308 at the distal end of the neck 112. The mounting interface 308 may be inspected to ensure that the upper wall 310, lower wall 304, guiding rail 306, upper rail 350, and gap 352 are properly formed and dimensioned.

The flosser head 104 or 600 may be attached to the mounting interface 308 by aligning the step 406 or 606 with either the upper wall 310 or the lower wall 304. The flosser head may be pressed onto the mounting interface 308 until the notches 502 or 608 engage with the corresponding sidewalls 702 or 704. The engagement may produce a tactile or audible click indicating secure attachment. The assembled electric flosser 100 may be tested for proper operation of the motor, the on/off button 106, and the attachment mechanism.

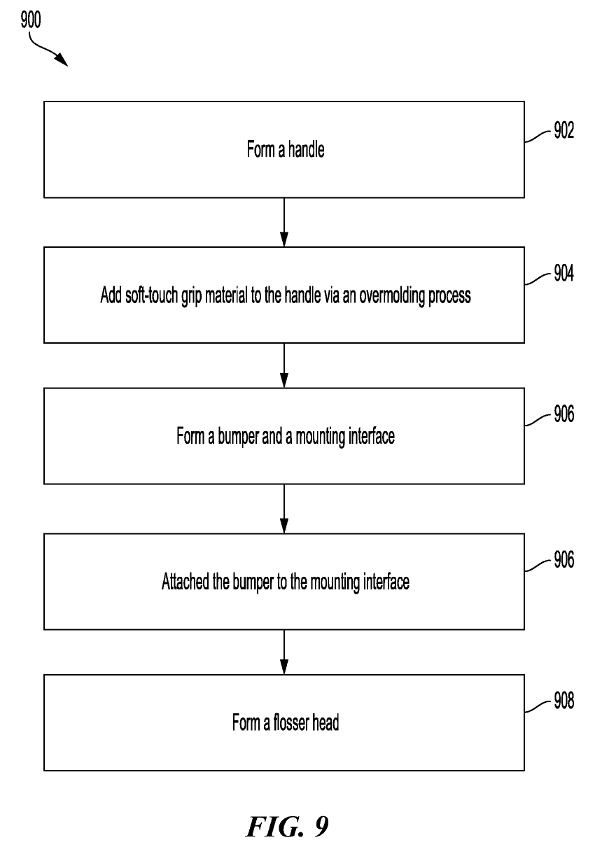

FIG. 9 illustrates a process 900 for manufacturing the electric flosser 100 and the flosser head 104 or 600, in accordance with various aspects of the present disclosure. The process 900 may include a series of blocks representing sequential manufacturing operations. The process 900 may begin at block 902 and proceed through subsequent blocks 904, 906, 908, and 910. Still, the sequence is not limited to the sequence shown in FIG. 9, other sequences are contemplated.

At block 902, the handle 108 may be formed. The handle 108 may be molded from a thermoplastic material, for example, by injection molding, and may include internal features for mounting a motor and other components. At block 904, the handle 108 may be overmolded with a soft-touch grip material. A thermoplastic elastomer may be injected over selected regions of the handle 108 to provide enhanced grip and comfort.

At block 906, a bumper 102 and a mounting interface 308 may be formed. The bumper 102 may be molded from a compliant material, such as by compression molding or injection molding, and may include integral features for attachment to the mounting interface 308. The mounting interface 308 may be formed integrally with a neck 112 or as a separate component and may include an upper wall 310, a lower wall 304, a guiding rail 306, an upper rail 350, and a gap 352.

At block 908, the bumper 102 may be attached to the mounting interface 308. The bumper 102 may be secured through adhesive bonding, snap-fit engagement, or overmolding, and may be positioned to provide a desired floss-to-bumper offset when a flosser head is attached. At block 910, a flosser head 104 or 600 may be formed and assembled with the handle 108. The flosser head 104 or 600 may be molded from a rigid thermoplastic material and may include arms 202 or 604, an inner wall 300, a step 406 or 606, grooves 302a and 302b or 602, and notches 502 or 608. A floss strand 114 may be installed onto the flosser head by threading the floss strand 114 through holes or slots in the arms, tensioning the floss strand 114, and securing the floss strand 114. A motor and electrical components may be assembled into the handle 108 and electrically connected to an on/off button 106 and a power supply compartment. A battery cap 110 may be attached to the handle 108, for example, using a threaded connection or a snap-fit mechanism, to provide access to the power supply compartment. The flosser head may be attached to the mounting interface 308 by aligning the step 406 or 606 with either the upper wall 310 or the lower wall 304 and pressing the flosser head onto the mounting interface 308 until the notches 502 or 608 engage with corresponding sidewalls 702 or 704. The assembled electric flosser 100 may be inspected and tested for proper operation. The process of forming the flosser head 104 or 600 may be independent of the process 900 described with reference to blocks 902, 904, 906, and 908.

The process 900 may be repeated to manufacture additional electric flossers 100 and flosser heads 104 and 600. The process 900 may be adapted to accommodate variations in materials, geometries, or assembly methods, and may be performed using automated or semi-automated manufacturing equipment to improve efficiency and consistency.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A flosser comprising:
a handle comprising a bumper and a stepped mounting interface having at least a first wall and a second wall defining a vertical offset;
a flosser head removably attachable to the handle, the flosser head comprising:
a pair of opposing arms;
a floss strand tensioned between the opposing arms; and
a step projecting from an inner surface of the flosser head and configured to selectively engage either the first wall or the second wall of the stepped mounting interface, engagement of the step with the first wall positions the bumper a first distance from the floss strand, and engagement of the step with the second wall positions the bumper a second distance from the floss strand, the second distance being greater than the first distance.

2. The flosser of claim 1, wherein:
the flosser is an electric flosser; and
the handle further comprises a motor and a power supply.

3. The flosser of claim 2, wherein the power supply comprises a rechargeable battery.

4. The flosser of claim 2, wherein the motor generates ultrasonic vibrations at a rate of at least 8,000 strokes per minute.

5. The flosser of claim 2, wherein the power supply comprises a replaceable battery housed within a base of the handle.

6. The flosser of claim 1, wherein the flosser head is removably attachable to the handle via a snap-fit connection.

7. The flosser of claim 1, wherein the bumper comprises a soft elastomeric material.

8. The flosser of claim 1, wherein the opposing arms of the flosser head taper from a wider base to a narrower distal end.

9. The flosser of claim 8, wherein the opposing arms are configured to pass between teeth and orthodontic brackets.

10. The flosser of claim 1, wherein, relative to the vertical offset of the stepped mounting interface, the first wall is an upper wall and the second wall is a lower wall.

11. The flosser of claim 1, wherein the first wall extends horizontally beyond the second wall toward an opening of the stepped mounting interface.

12. The flosser of claim 1, wherein:
the first distance is less than or equal to 3 mm; and
the second distance is greater than 3 mm and less than or equal to 5 mm.

13. A flosser, comprising:
a handle comprising a stepped mounting interface with a first wall and a second wall that are vertically arranged;
a flosser head attachable to the handle, the flosser head comprising a pair of opposing arms and a floss strand tensioned therebetween, the flosser head further comprising a step configured to engage either the first wall or the second wall of the stepped mounting interface; and
a bumper at a distal end of the handle, engagement of the step with the first wall positions the bumper at a first distance from the floss strand, engagement of the step with the second wall positions the bumper at a second distance from the floss strand.

14. The flosser of claim 13, wherein engaging the first wall positions the bumper approximately 3 millimeters from the floss strand, and engaging the second wall positions the bumper approximately 5 millimeters from the floss strand.

15. The flosser of claim 13, wherein the flosser head is an orthodontic flosser head comprising opposing arms that taper from a wide base to a narrow distal end.

16. The flosser of claim 13, wherein:
the flosser is an electric flosser, and
the handle further comprises a motor configured to vibrate the floss strand.

17. The flosser of claim 16, wherein the motor is configured to vibrate the floss strand at a frequency of at least 8,000 strokes per minute.

18. The flosser of claim 13, wherein the flosser head is removably attachable to the handle via a snap-on/snap-off connection.

19. The flosser of claim 13, wherein:
the first wall is an upper wall; and
the second wall is a lower wall.

20. A method of manufacturing a flosser, comprising:
forming a handle comprising a neck and a stepped mounting interface, the stepped mounting interface comprising a first wall and a second wall arranged vertically with respect to one another;
attaching a bumper to a distal end of the neck such that the bumper is positioned adjacent to the stepped mounting interface;
forming a flosser head comprising:
a pair of opposing arms;
a step projecting from an inner surface of the flosser head; and
a floss strand tensioned between the opposing arms, the flosser head being configured to be removably attachable to the stepped mounting interface such that the step selectively engages either the first wall or the second wall of the stepped mounting interface, engagement of the step with the first wall positions the bumper a first distance from the floss strand, and engagement of the step with the second wall positions the bumper a second distance from the floss strand, the second distance being greater than the first distance.
